(19) United States
(12) Patent Application Publication
(10) Pub. No.: US 2008/0283516 A1
(43) Pub. Date: Nov. 20, 2008

(54) Current Supply for Heaters

(75) Inventors: Ilse Talle, Rheine (DE); Jorn Schroer, Herdecke (DE)

Correspondence Address: Jason H. Vick;Sheridan Ross, PC, Suite # 1200, 1560 Broadway, Denver, CO, 80202, US

(73) Assignee: EWALD DORKEN AG, Herdecke (DE)

(21) Appl. No.: 11/908,194

(22) PCT Filed: Mar. 8, 2006
(86) PCT No.: PCT/EP2006/002124

§ 371 Date: Apr. 25, 2008

(30) Foreign Application Priority Data
Mar. 8, 2005 (DE) 10 2005 010 470.3

(51) Int. Cl. H05B 1/02

(52) U.S. Cl. 219/490

(57) ABSTRACT

The invention relates to a current supply device for a surface resistance heater, a heating system and to a method for supplying a surface resistance heater with current. The resistance of the surface resistance heater is measured in a continuous manner in order to detect short-circuits. In the event of a short-circuit, the current is limited or cut-off. Said current supply device is, preferably, embodied as a skirting board or as a cover strip.

The invention chiefly relates to an inverter as a current supply element with technology in the safety extra-low voltage range for alternating or direct current from 0 volts up to an appropriate upper safety extra-low voltage limit. In particular, surface resistance heaters are intended to be heated with this technology. The present invention generally relates to a current supply device, preferably a power supply, for supplying a surface resistance heater or a comparable heater with current.

In further detail, the present invention relates to a current supply device as set forth in the preamble of claim 1 or 6, a heating system as set forth in the preamble of claim 30, a surface resistance heater as well as a method for supplying a surface resistance heater with current as set forth in the preamble of claim 57.

A switched-mode power supply for surface resistance heaters is known from WO 2004/113798 A1. This switched-mode power supply works as an inverter. Primary-pulsed inverters in this range of capacity have condensers in the primary circuit in order to smooth out the unidirectional sine input voltage. These smoothing condensers produce a phase shift between input voltage and input current. Since this phase shift leads to undesired effects for power supply companies, so-called Power Factor Controllers (PFCs) are prescribed starting at a certain power class. These PFCs limit, control or regulate particularly the idle current or the idle power. Depending on the power, these PFCs require lesser or greater volumes and are associated with considerable costs. A further disadvantage of the known switched-mode power supply is that, in the event of a short circuit in the connected resistance heater, an overload or overheating and, particularly, destruction can occur.

It is the object of the present invention to provide a universally usable and/or compact current supply device as well as a heating system, a surface resistance heater, and a method for supplying a surface resistance heater with current, particularly wherein, by reducing the size, the possibility is created for accommodating the electronics within a volume that allows for the power supply to be embodied for example as a concealed assembly in a small concealed housing, and/or wherein the current supply and the surface heater, such as a heating wallpaper, are themselves protected in the event of damage, for example from nails, screws, plugs, or other metallic objects.

The abovementioned object is achieved by means of a current supply device as set forth in claim 1 or 6, a heating system as set forth in claim 30, a surface resistance heater as set forth in claim 56, or a method as set forth in claim 57. Advantageous modifications are the object of the subsidiary claims.

According to a first aspect of the invention, the current supply device or a control which is preferably integrated into the current supply device for protecting the system consisting of current supply device and connected heater measures the resistance of the heater, particularly foil—preferably continuously or permanently—and hence detects any damage to the heater (foil, heating wallpaper or the like). Particularly, when an excessively strong drop in the electrical resistance (overshoot of a rate of change and/or undershoot of a minimum value) or short circuit—for example due to damage to the surface heater—is detected, the supply of current is interrupted or limited. In this way, an undesired overheating of the surface heater and ensuing damage can be prevented, for example. Furthermore, in this way an overloading of the current supply device through excess heating—particularly in the case of concealed assembly—can be ruled out in a simple manner.

In particular, according to a preferred modification, several surface heaters can be connected to the current supply device, particularly in such a manner that the resistances for the individual heaters can be detected independently of each other and/or the heaters can be shut off [or] regulated independently of each other and/or their current can be limited.

According to a second, also independently implementable aspect of the present invention, the current supply device is embodied as a floor, base, wiper, ceiling or wall strip or track or at least as a section of such a strip or track or is usable as such or can be integrated or used therein. Especially preferably, the current supply device is designed to be commensurately track- or profile-like, particularly oblong or rod-shaped. This allows for the universal use of the proposed current supply device and, particularly, the simple upgrading of buildings, rooms or the like with the current supply device.

The current supply device is particularly embodied as an inverter. The primary part of the inverter preferably does not contain any smoothing condensers and/or PFCs. This is completely sufficient for use as a power source for a surface heating element. The degree of efficacy increases due to the losses omitted for PFC and smoothing or intermediate circuit condensers.

Preferably, a rectification does occur on the secondary side as well as on the primary side, but no smoothing. In particular, a high-frequency filter is sufficient. Accordingly, secondary-side smoothing condensers can also be omitted, so the construction size and costs can be minimized accordingly.

The inverter preferably has a regulator which is particularly designed such that it does not correct the unidirectional but unsmoothed output current or alternating current.

The current supply device is preferably embodied such that a connection surface is provided in which or on which at least one surface resistance heater, particularly a heating foil, or even several surface resistance heaters, particularly several heating foils, can be connected. The wiring of the individual heaters is variable.

The proposed current supply device is preferably cooled without outside cooling or with a fan, with one or more cooling elements, or using a mechanism not described in any further detail here. Alternatively or in addition, the housing of the current supply device is designed to cool the current supply device and, particularly, is made at least partly of metal for this purpose. Alternatively or in addition, for cooling and/or simple assembly, the current supply device can also be provided with a metallic track, be embodied as such, or be attachable thereto.

To be able to use the current supply device around the world or as universally as possible, it preferably has an input voltage range of 90 to 400 VAC or volts. Particularly, the frequency of the input voltage is variable in the region of 50 to 60 Hz. Alternatively or in addition, each desired power level of the current supply device or the inverter achievable with safety extra-low voltage can be implemented or set.

The proposed surface resistance heater is particularly quite resistant to damage, for example from nails, screws or the like, and even then it produces no short circuit or is short-circuit-proof.

Further features, advantages, aspects, and characteristics of the present invention follow from the claims and the following description of a preferred embodiment on the basis of the drawing.

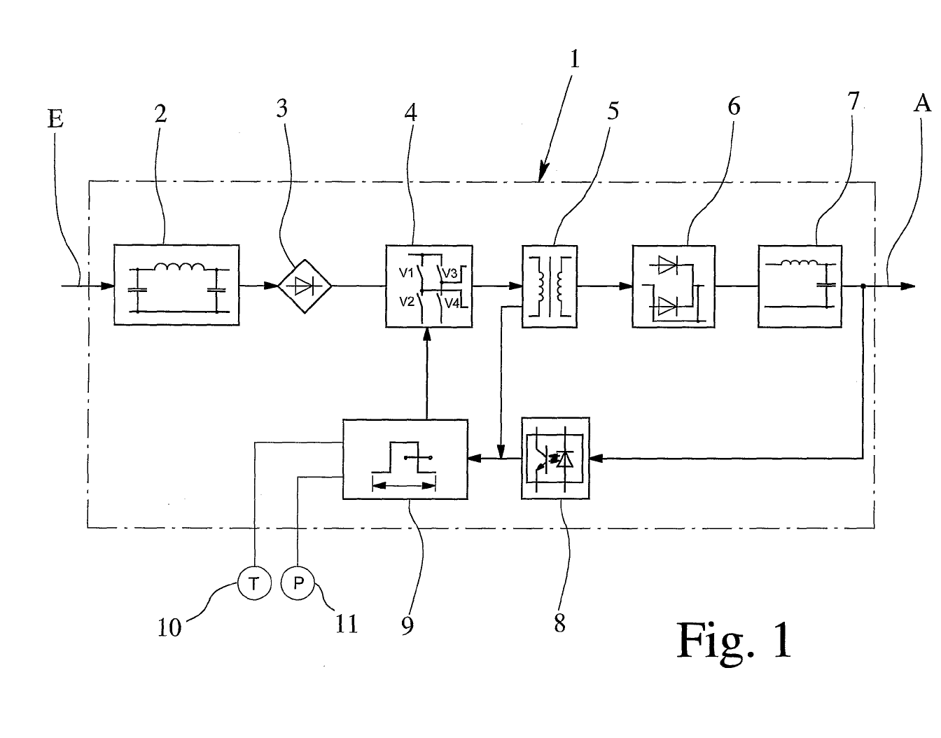

FIG. 1 shows a schematic block diagram of a proposed current supply device; and

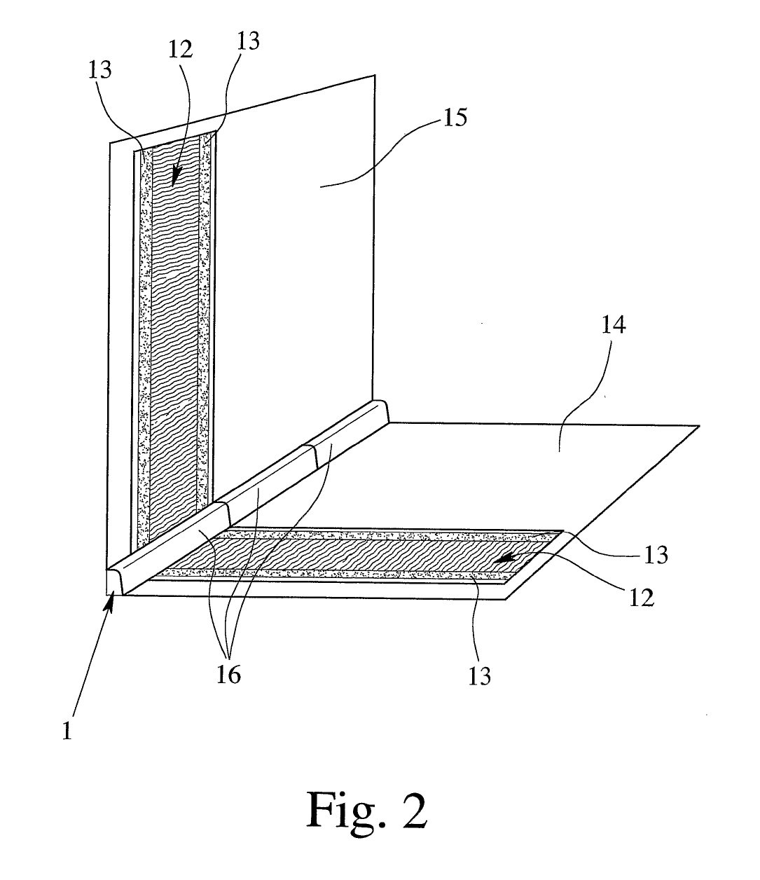

FIG. 2 shows a schematic block diagram-like representation of a proposed heating system with the current supply device and at least one allocated surface heater.

FIG. 1 shows a schematic block diagram of a proposed current supply device 1. The current supply device 1 is particularly used to supply at least one surface resistance heater 12, as indicated in FIG. 2, or the like with current.

The current supply device 1 has an input E for connection to supply voltage. Preferably, the current supply device 1 can be connected to alternating current from 90 to 400 volts, particularly at least essentially 230 volts.

The current supply device 1 optionally has an input filter 2, particularly an EMC filter.

The current supply device 1 preferably has a rectifier 3 which rectifies the alternating current, particularly into positive half-waves.

The current supply device 1 preferably has no direct current smoothing on the primary side, particularly no smoothing condenser or the like. Moreover, the current supply device 1 has no PFC or the like. However, as an alternative, direct current smoothing and/or a PFC can also be provided.

The direct current is fed via switches V1 to V4 or a full bridge 4 or another suitable switching device, particularly one which can be pulsed or modulated, to a transformer or power transformer 5 of the current supply device 1.

On the secondary side, a secondary rectifier 6 which rectifies the alternating current emitted from the power transformer 5 is connected to the power transformer 5, hence producing, particularly, positive half-waves.

The current supply device 1 preferably has no secondary-side direct current smoothing. However, this is possible in principle.

In the depicted example, the current supply device 1 optionally has an output filter 7 on the secondary side which particularly filters out high-frequency interference or harmonics, as is preferably also the case with the optional input filter 2.

The current supply device 1 has a connection A for the output voltage, particularly a safety extra-low voltage. Connectable or connected to the connection A is at least one surface resistance heater 12.

In addition, the current supply device 1 has a control and/or regulating device, particularly a regulator 9. In the depicted example, the regulator 9 is preferably connected via an optional optocoupler 8 to the output A of the current supply device 1—particularly to detect the output voltage and/or the output current. Moreover, the regulator 9 is preferably connected to the primary side of the power transformer 5—particularly to detect current.

In the depicted example, the control or regulating device, particularly the regulator 9, controls the switches V1 to V4 or the full bridge 4 or other switching device, particularly for the input- or primary-side pulsing of the current supply device 1 or the current fed to the power transformer 5, preferably through pulse width modulation. The pulsing or modulation is performed particularly at a frequency from 3 to 150 kHz. Preferably, the controlling is performed such that the switches V1 and V4 are alternately closed and the switches V2 and V3 opened and vice-versa.

The current supply device 1 or its control or regulation is preferably designed such that the output voltage can be regulated or controlled, preferably from 0 volts up to a safety extra-low voltage limit of 30 or 36 or 60/66 volts (effective power or peak power), especially preferably in a stepless manner.

The regulation or its time constant is preferably set up to be sufficiently slow, such that the fluctuations of the output voltage are preferably not corrected when there is no secondary-side direct current smoothing. However, regulation is also possible in principle which corrects these fluctuations in voltage and, particularly, results in smoothing.

The proposed current supply device 1 preferably converts the input-side direct current into alternating current. The current supply device 1 is therefore particularly embodied as an inverter or functions as such. However, other implementations are also possible in principle; for example, in principle, the supply direct current can also be pulsed appropriately without rectification or modulated or modified in some other manner.

In the depicted example, a temperature sensor 10 such as an NTC can preferably be connected to the current supply device 1, preferably wirelessly or without line-conduction, particularly via infrared or radio. Alternatively, however, connection via a cable or the like is also possible.

The temperature sensor 10 is particularly used to detect the room temperature. It is situated preferably in the proximity of or relatively far removed from the current supply device 1 at the appropriate location.

Particularly, the temperature sensor 10 makes an actual value available for preferred controlling or regulation of the room temperature.

The current control supply device 1 is preferably a control device such as a potentiometer 11 or the like, particularly for adjusting the heat output and/or for switching on and off. In the depicted example, the control device is preferably connected wirelessly or without line conduction—particularly via infrared or radio—to the current supply device 1. However, the control device can also be connected as needed via cable or the like to the current supply device 1 or arranged on the current supply device 1 or be integrated into same.

The control device or potentiometer 11 is used particularly to prescribe a desired temperature, i.e. a nominal value, for preferred temperature regulation, particularly the regulator 9.

The current supply device 1 is preferably embodied such that the electrical resistance of at least one connected surface resistance heater 12 is measurable or detectable. In the depicted example, this is preferably done, on the one hand, through measurement or detection of the output voltage and, on the other hand, through detection of the primary-side and/or output-side current.

The resistance is continuously or permanently monitored by the current supply device 1 or the regulator 9 or another control or regulating device of the current supply device 1.

Upon detection of an excessively strong drop in the electrical resistance (overshoot of a rate of change and/or undershoot of a minimum value) or upon detection of a short circuit of the surface resistance heater 12, the current or the current supply for the surface resistance heater 12 is preferably shut off or at least limited. The limitation can be set, for example, at a prescribed value or at a previous—optionally averaged—value prior to the detection of the excessively strong drop in the electrical resistance or a short circuit. Accordingly, for example, in the event of damage to the surface resistance heater 12 by a metallic object or otherwise, possible overheating and possible further destruction of the surface resistance heater 12 and/or possible overheating and possible destruction of the current supply device 1 and/or other objects are prevented.

Alternatively or in addition to the electrical resistance, a value proportional to this or otherwise correlated value, particularly the electrical current, can be monitored in an analogous manner.

According to a first modified embodiment, only a single surface resistance heater 12 can be connected to the current supply device 1. According to a second modified embodiment, several surface resistance heaters 12 can be connected to the current supply device 1, particularly in parallel and/or in series.

In the case of the second embodiment, the surface resistance heaters 12 or their heating elements can preferably be supplied with current individually or in groups independently of each other, and/or their electrical resistances or their currents can be measured or detected, particularly so that, in the event of excessively strong drop in resistance or short circuit, the surface resistance heaters 12 or their heating elements can be shut off or limited in current individually or in groups.

According to another modified embodiment, the current supply device 1 is preferably embodied such that the output voltage is always limited to a maximum value relative to or in addition to the already-explained resistance monitoring and current shut-off or limitation in the case of an excessive drop in resistance or a short circuit.

The individual components or elements of the current supply device 1 are preferably accommodated in a common housing. Alternatively or in addition, the components or elements are particularly cast into plastic.

The current supply device 1 is preferably designed to be water-tight. This can realized in a very simple and cost-effective manner, particularly through casting in plastic.

FIG. 2 shows in a schematic representation a proposed heating system consisting of a current supply device 1 and at least one surface resistance heater 12 as well as a proposed surface resistance heater 12. In the depicted example, two surface resistance heaters 12 are connected to the same current supply device 1.

The connection of the surface resistance heater 12 can be performed respectively, for example, by guiding electrodes 13 of the surface resistance heaters 12 directly to a corresponding contact surface on and/or in the housing of the current supply device 1. Alternatively, a connection can also take place via electric cables (not depicted) or the like. The cables, for example, can then be connected to the current supply device 1 using a plug or be firmly connected thereto. Particularly in the latter case, the cables preferably have appropriate connection devices, contact surfaces or the like on their other ends for electrical connection to the respective surface resistance heater 12 or electrode 13.

The surface resistance heaters 12 or their heating elements connected or connectable to the current supply device 1 are preferably made of conductive carbon, carbon fibers, a carbon mixture with non-conductive materials, a carbon fiber fleece, a carbon fiber/glass fiber fleece mixture, carbon fiber woven fabric, carbon fiber/glass fiber woven fabric mixture, graphite with a conductive binding agent provided on a substrate, or a nanotube carbon fiber spun yarn or a nanotube carbon fiber mixture with non-conductive materials or mixtures thereof or consist thereof. Particularly, an electrically conductive heating layer consists of this material or these materials. The electrodes 13, which are particularly embodied as parallel strips, are then preferably provided in addition. Moreover, another substrate layer, covering layer, insulation, or the like can be provided.

The surface resistance heater 12 heats particularly over the entire surface and is preferably designed to be flexible, particularly foil-like, fleece-like or fabric-like. This allows for a simple construction and universal use.

Instead of the surface resistance heater 12 described in the foregoing, however, other surface resistance heaters or other heaters can also be connected to the proposed current supply device 1 in principle.

For example, the surface resistance heaters 12 can be laid onto or built into a floor 14 and/or a wall 15 such as is depicted as an example in FIG. 2.

The current supply device 1 can be embodied, for example, as a concealed socket or designed or provided for other types of installation. Preferably, however, the current supply device 1 is designed to be track-, profile- or rod-like or oblong.

In the depicted example, the current supply device 1 is especially preferably installable as a floor, base, wiper, ceiling or wall strip 16 or at least as a section thereof or can be integrated into such a strip 16. This allows for very universal use and simple surface-mounting. The preferred design of the current supply device 1 as a floor, base, wiper, ceiling or wall strip 16 or at least as a section thereof facilitates a particularly simple connection of the allocated surface resistance heater 12, particularly if it extends under the current supply device 1 or strip 16, since required connections or the like are then preferably covered by current supply device 1 or strip 16.

As needed, the current supply device 1 can be connected to a preferably metallic track and/or forms at least a portion of a preferably metallic track. This allows for simple mounting and, particularly, the use as the aforementioned strip 16.

Especially preferably, the current supply device 1 has an at least partially metallic housing for cooling. Alternatively or in addition, cooling can take place via the aforementioned metallic track.

Alternatively or in addition, several current supply devices 1 can also be connected, particular plugged, to each other, especially preferably for mechanical and/or electrical connection. Particularly, such an input-side and/or output-side parallel arrangement of the current supply device 1 is possible in a very simple manner. Moreover, a modular construction is facilitated.

1.-58. (canceled)

59. Current supply device, particularly inverter, as a current supply or current delivery element, preferably with technology in the safety extra-low voltage range for alternating or direct current from 0 volts up to an appropriate upper safety extra-low voltage limit for at least one surface resistance heater, wherein the current supply device is designed for the measurement or detection of the resistance of the surface resistance heater.

60. Current supply device as set forth in claim 59, wherein the current supply device is designed for concealed mounting, particularly as a concealed socket.

61. Current supply device, particularly inverter, for at least one surface resistance heater, particularly as set forth in claim 59, wherein the current supply device is designed as a floor, base, wiper, ceiling or wall strip or at least as a section thereof or can be integrated therein.

62. Current supply device as set forth in claim 59, wherein the current supply device is preferably sealed water-tightly.

63. Current supply device as set forth in claim 59, wherein the current supply device or the secondary portion of the current supply device has a regulator which corrects or does not correct fluctuations in voltage—particularly those which occur due to a lack of a secondary-side direct current smoothing.

64. Current supply device as set forth in claim 59, wherein the current supply device functions without direct current smoothing on the primary and/or secondary side.

65. Current supply device as set forth in claim 59, wherein the current supply device has a primary circuit regulator which preferably functions without or with intermediate circuit condenser.

66. Heating system with a current supply device and a surface resistance heater, wherein the current supply device is embodied as set forth in claim 59 and/or as an inverter, and/or that the surface resistance heater or its heating element particularly consists of or is produced from conductive carbon, carbon fibers, a carbon mixture with non-conductive materials, a carbon fiber fleece, a carbon fiber/glass fiber fleece mixture, carbon fiber woven fabric, carbon fiber/glass fiber woven fabric mixture, graphite with a conductive binding agent provided on a substrate, or a nanotube carbon fiber spun yarn or a nanotube carbon fiber mixture with non-conductive materials.

67. Heating system as set forth in claim 66, wherein the current supply device is designed for concealed mounting, particularly as a concealed socket.

68. Surface resistance heater, wherein the surface resistance heater or its heating element consists or is produced from conductive carbon, carbon fibers, a carbon mixture with non-conductive materials, a carbon fiber fleece, a carbon fiber/glass fiber fleece mixture, carbon fiber woven fabric, carbon fiber/glass fiber woven fabric mixture, graphite with a conductive binding agent provided on a substrate, or a nanotube carbon fiber spun yarn or a nanotube carbon fiber mixture with non-conductive materials.

69. Method for supplying a surface resistance heater with current, particularly wherein equal-ratio supply voltage is transformed by means of a preferably primary-side-pulsed inverter and a transformer or power transformer and is given off as a preferably unidirectional low voltage to the surface resistance heater and/or wherein a low voltage which can be adjusted from 0 volts up to the safety extra-low voltage limit or is variable is given off to the surface resistance heater, wherein the resistance of the surface resistance heater is measured continuously and that, upon detection of an excessively strong drop in resistance or a short circuit, the current is limited or shut off.

70. Method as set forth in claim 69, wherein a current supply device as set forth in claim 66 is used.
